(19) United States
(12) Patent Application Publication
(10) Pub. No.: US 2018/0121406 A1
(43) Pub. Date: May 3, 2018

(54) EMBEDDED SERVICE PROVIDER DISPLAY FOR A COLLABORATIVE WORKSPACE ENVIRONMENT

(71) Applicant: Microsoft Technology Licensing, LLC, Redmond, WA (US)

(72) Inventors: William James Bliss, Bellevue, WA (US); Larry Jin, Bellevue, WA (US); Richard Taylor, Sammamish, WA (US); Pedro DeRose, Redmond, WA (US)

(73) Assignee: Microsoft Technology Licensing, LLC, Redmond, WA (US)

(21) Appl. No.: 15/445,489

(22) Filed: Feb. 28, 2017

Related U.S. Application Data
(60) Provisional application No. 62/415,891, filed on Nov. 1, 2016.

(51) Int. Cl. G06F 17/24; G06F 17/22; G06F 9/44

(52) U.S. Cl. CPC G06F 17/243; H04L 67/02; G06F 9/4443; G06F 17/2247

(57) ABSTRACT

Described herein are systems and methods for embedding a service provider display within a user interface for a collaborative workspace environment. The display may be generated based on information and resources provided by a service provider. The display may be used to select content provided by the service provider. Information gathered by the display may then be used by the service provider to provide one or more entities relating to the requested content to the collaborative workplace environment. The entities may be stored and used to generate a display of the selected content from the service provider. In some examples, the entities may be shared within the collaborative workspace environment such that other users may generate a similar view using the entities provided by the service provider. In some examples, the entities may comprise a URL relating to a webpage associated with the selected content.

### CROSS-REFERENCE TO RELATED APPLICATION

This application claims priority to U.S. Provisional Application No. 62/415,891, entitled “Embedded Service Provider Display for a Collaborative Workspace Environment,” filed on Nov. 1, 2016. the entire disclosure of which is hereby incorporated by reference in its entirety.

### BACKGROUND

In current collaborative workspace environments, there is not a convenient and easy way or mechanism for integrating content provided from various service providers. For example, if a developer wishes to provide a content selection interface to incorporate content stored by a third-party service, the developer must utilize the application programming interface (API) provided by the service provider. More specifically, the developer must have an understanding of the options and functionality made available by the API and develop software specifically designed to integrate with the service provider. This becomes unwieldy when attempting to integrate with a large number of service providers.

It is with respect to these and other general considerations that embodiments have been described. Also, although relatively specific problems have been discussed, it should be understood that the embodiments should not be limited to solving the specific problems identified in the background.

### SUMMARY

This disclosure generally relates to systems and methods for embedding a service provider display within a user interface (UI) of a collaborative workspace environment. More specifically, the present disclosure describes a user interface that may generate a display based on information and resources provided by a service provider. As an example, a uniform resource locator (URL) or other identifier may be provided which may be used to retrieve a webpage. The webpage may be displayed within the user interface using a frame (e.g., an iframe) or similar interface element. More specifically, the collaborative workspace environment may embed the specific content specified by the URL within the user interface, thereby enabling user input and interaction with the webpage. The webpage may comprise a variety of input fields, which may be used to provide information to the service provider. In some instances, the collaborative workspace environment may not have knowledge of and/or access to the specific content.

The display may be used to specify or select content from the service provider for inclusion in the collaborative workplace environment even if the collaborative workspace environment has no knowledge about the content from the service provider. Once the user has completed the content selection process, information from the display may be used by the service provider to provide one or more entities to the collaborative workplace environment relating to the requested content. In some examples, the entities may comprise a URL which may be used by the collaborative workplace environment to access the content. The entities may be stored and used to generate a display of the selected content from the service provider. In some examples, the entities may be shared within the collaborative workspace environment such that other users may generate a similar view using the entities provided by the service provider.

Accordingly, disclosed herein is a system comprising at least one processing unit and at least one memory storing computer executable instructions which, when executed by the at least one processing unit, performs a method for displaying content that is specific to a third party content provider or service provider.

When the one or more resources are received from the service provider, a first display is generated within a user interface of a collaborative workspace environment using the one or more resources. The first display includes one or more input fields. An input is received in the one or more input fields of the first display. In response to receiving the input in the one or more input fields, one or more entities are received from the service provider. In some examples, the one or more entities are associated with the input. A second display containing the one or more entities is generated within the user interface of the collaborative workspace environment.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system for providing a collaborative workspace environment.

FIG. 2 illustrates an example user interface comprising an embedded service provider display.

FIG. 3 illustrates the example user interface of FIG. 2 with a different view of the embedded service provider display.

FIG. 4 illustrates the example user interface view of FIG. 3 where information has been entered in the display.

FIG. 5 illustrates the example user interface of FIG. 2 in which a new canvas has been added to the user interface based on information entered in FIG. 4.

FIG. 6A illustrates the example user interface of FIG. 2 with an embedded service provider display.

FIG. 6B illustrates the example user interface of FIG. 6A where an item has been selected from the embedded display.

FIG. 7 illustrates an example method for an embedded service provider display.

FIG. 8 is a block diagram illustrating example physical components of a computing device with which aspects of the disclosure may be practiced.

FIGS. 9A and 9B are simplified block diagrams of a mobile computing device with which aspects of the present disclosure may be practiced.

FIG. 10 is a simplified block diagram of a distributed computing system in which aspects of the present disclosure may be practiced.

FIG. 11 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

This disclosure generally relates to an embedded service provider display for a collaborative workspace environment. In general, the collaborative workspace environment displays or otherwise provides a user access to multiple groups in the collaborative workspace environment that the user is associated with. Each group may have one or more contexts and each context has a workspace in which content may be displayed and/or shared with other members of the group. Each member of the group, may access, edit, comment, post or otherwise interact with the content that is displayed in the workspace. Content may be added to the collaborative workspace environment from one or more service providers.

As used herein, a service provider may be a third party or external service provider (e.g., video content website) or may be a local service provider (e.g., a word processing application) hosted by a server computing device or stored locally on a client device. Example service providers include, but are not limited to, software applications and internet services (e.g., social network websites, photo sharing websites, etc.). A service provider may provide content that is associated with one or more entities, which may include documents, dashboards, conversations or chats, video content, pictures, and webpages, among others. Finally, context may include a tenant, a team, and a channel or conversation topic, among others.

In order to add content from a service provider, a display (e.g., a configuration UI) may be embedded within the user interface of the collaborative workspace environment. The display may be generated based on information provided by or retrieved from the service provider. As a result, the service provider may be able to control or design the appearance and user experience of the display. Thus, the content may keep its indented or original design although it is being shown or otherwise displayed in the collaborative workspace environment.

For example, the information provided from the service provider may indicate specific information or resources to use when generating the display. As an example, a URL or other identifier may be provided which may be used to retrieve a webpage for display. The webpage may be displayed within the user interface of the collaborative workspace environment using a frame (e.g., an iframe) or similar interface element. Although frames are specifically mentioned, other graphical elements may be provided and used to generate the display.

A user may interact with the embedded service provider display to select or further specify which content from the service provider should be added to the collaborative workspace environment. For example, a user may navigate a directory structure, input additional information (e.g., authentication credentials), or search for specific content, among other actions. Once the service provider has determined that the user has completed the content selection process, the service provider may provide an indication to the collaborative workspace environment.

In some examples, the indication may be provided by executing a callback function within the display. The callback function may be part of an API made available by the collaborative workspace environment (e.g., a JavaScript function that may be executed by the display to alert the collaborative workspace environment that the content selection process is complete).

As a result of the indication, the collaborative workspace environment may perform processing relating to the embedded service provider display. As an example, the collaborative workspace environment may update other elements of the user interface (e.g., a “Save” button may become enabled, thereby enabling a user to save the content selection). In other examples, the collaborative workspace environment may automatically perform additional tasks associated with the service provider display (e.g., the content addition may be automatically saved rather than prompting for further user input). The collaborative workspace environment may then submit the information provided within the display to the service provider.

In response to the submission from the collaborative workspace environment (e.g., sent as a result of the user pressing “Save”), the service provider may provide one or more entities relating to the content addition. Alternatively, the service provider may provide the one or more entities without any additional action by the collaborative workspace environment, and may instead send the entities as a result of determining that the user has completed the content selection process within the embedded service provider display.

The one or more entities may be stored and retrieved to generate a display of the selected content from the service provider. In some examples, the one or more entities may comprise a URL relating to the content, wherein the URL may be stored and later retrieved by the collaborative workspace environment to generate a display of the content within the collaborative workspace environment. Additionally, the entities may be shared within the collaborative workspace environment, such that other users may generate a similar view using the entities provided by the service provider.

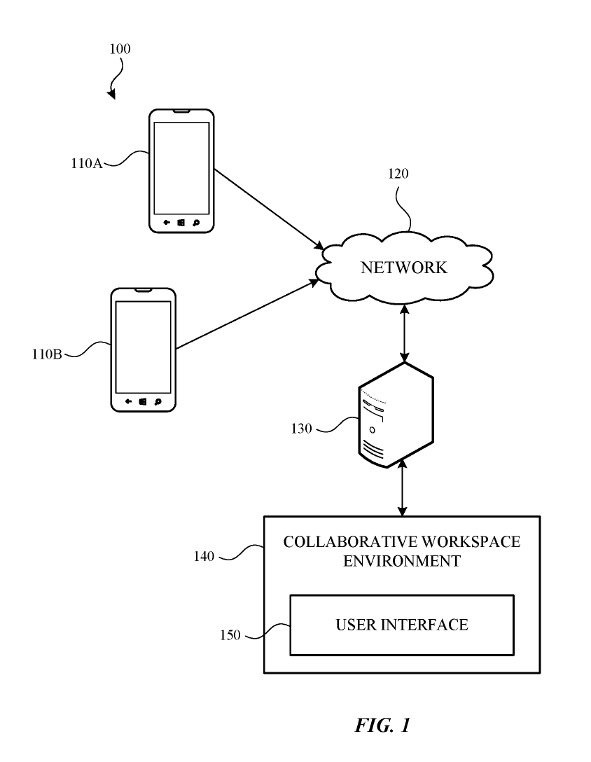

FIG. 1 illustrates an example system 100 for providing a collaborative workspace environment 140 according to an embodiment. In aspects, a client device, such as for example, client device 110A and client device 110B may access a network 130, or other internet connection, and access the collaborative workspace environment 140 executing on a server computing device 120.

In some embodiments, the client computing device 110A and the client computing device 110B (also referred to as client computing device 110) is a personal or handheld computer having both input elements and output elements. For example, the client computing device 110 may be one of: a mobile telephone; a smart phone; a tablet; a phablet; a smart watch; a wearable computer; a personal computer; a desktop computer; a laptop computer; a gaming device/computer (e.g., Xbox); a television; and the like. This list is for example purposes only and should not be considered as limiting. Any suitable client computing device for executing a messaging application may be utilized.

The system 100 is a communication system/service that provides the collaborative workspace environment 140 for users to communicate and collaborate over the network 120. In an example, the collaborative workspace environment 140 provides a configurable and extensible workspace for collaboration between users through a user interface 150 that may comprise a plurality of different views.

Users of the collaborative workspace environment 140 may be include but are not limited to: one or more persons, companies, organizations, departments, virtual teams, ad-hoc groups, vendors, customers, third-parties, etc. The collaborative workspace environment 140 enables visibility and communication between users including users who are organized in teams or groups as well as users/groups outside of a team/group.

More specifically, when a user accesses the collaborative workspace environment 140, the user may have access to one or more groups. Each group may be associated with various contexts that have a particular set of content. One or more canvases are associated with each context and each canvas has an associated workspace in which content, related to or otherwise filtered for the canvas and/or context is displayed. By selecting the various canvases that are displayed, different content, associated with each canvas, is provided in the workspace.

In some instances, each canvas may be used to provide content that multiple users may access, edit, and/or create. The content may be provided by various services—both local services (e.g., services, applications and products provided or otherwise hosted by the server 120) and external or third party services. Example services include, but are not limited to, word processing applications or services, spreadsheet applications or services, line-of-business (LOB) management services, customer relationship management (CRM) services, debugging services, accounting services, payroll services and so on. In other examples, the content associate with each canvas may include content from websites and/or applications, such as social media or networking websites, photo sharing websites, video and music streaming websites, messaging applications, search engine websites, sports, news or entertainment websites, and the like.

Content may be added using an embedded service provider display, wherein a service provider may provide information or resources that are used to generate an embedded display within the collaborative workspace environment. The display may be used to select specific content from the service provider. In some instances, the display, and more specifically, the collaborative workspace environment, does not have knowledge of and/or access to the specific content. However, after the content has been specified, the service provider provides one or more entities associated with the content which may be stored and used to display the selected content within the collaborative workspace environment.

In some instances, these services may provide robust reporting, analytics, data compilation and/or storage service, etc., whereas other services may provide search engines or other access to data and information, images, videos, document processing and the like.

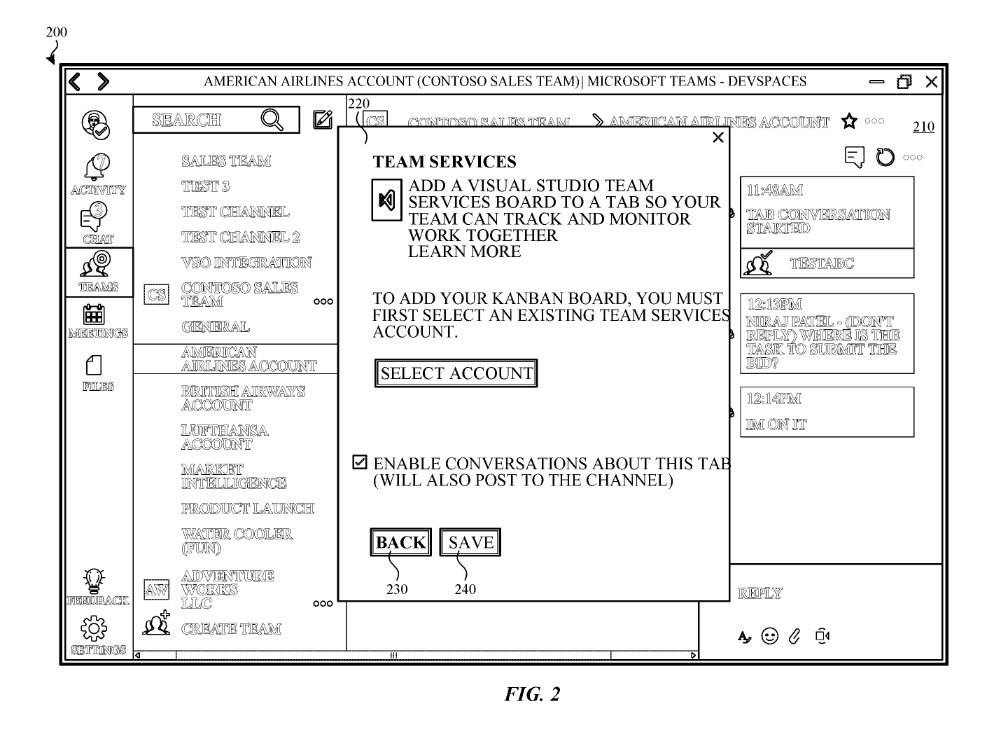

FIG. 2 illustrates an example user interface 200 of a collaborative workspace environment (e.g., the collaborative workspace environment 140 of FIG. 1) of the present disclosure, comprising an embedded service provider display. The user interface 200 may be similar to the user interface 150 described above in FIG. 1.

In aspects, the user interface 200 comprises workspace 210. Workspace 210 may contain a variety of content, including, but not limited to, documents, dashboards, conversations or chats, video content, pictures, and webpages. Content may be added using an embedded service provider display (e.g., configuration UI 220). Configuration UI 220 may retrieve specific information or resources specified by a service provider (e.g., “Team Services”) when generating the display. As an example, a uniform resource locator (URL) may be provided which may be used to retrieve a webpage for display within configuration UI 220. The webpage may be embedded using a frame (e.g., an iframe) or similar interface element.

Additionally, configuration UI 220 is comprised of “Back” button 230 and “Save” button 240, which may be used to control the operation of configuration UI 220. As an example, “Back” button 230 and “Save” button 240 may be displayed independent of the information or resources specified by the service provider.

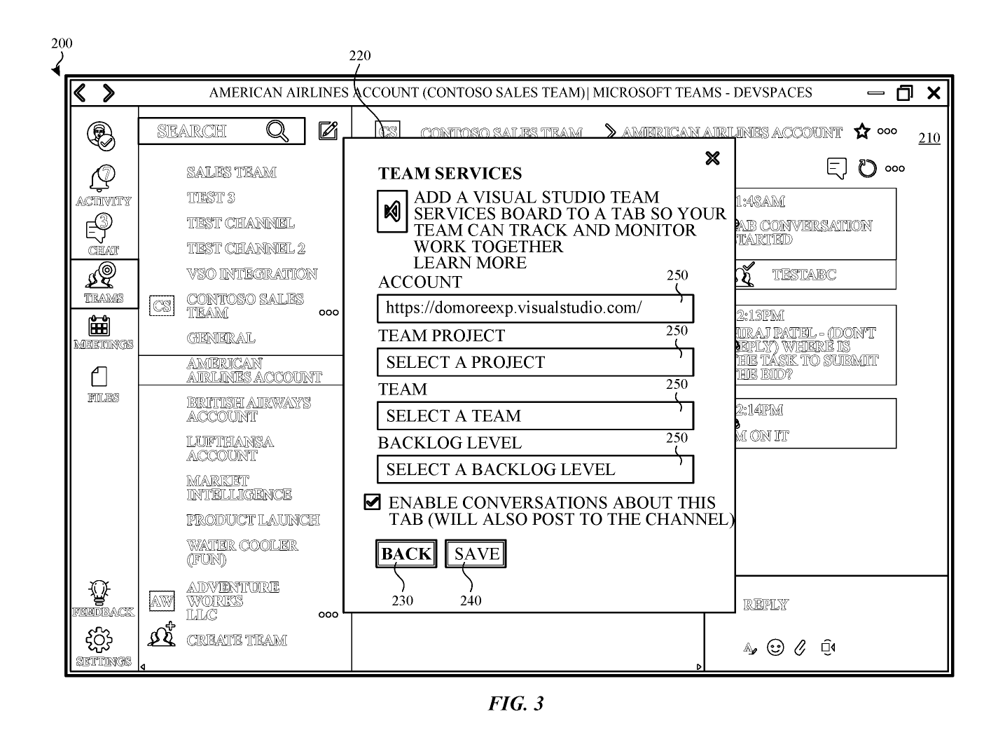

A user may interact with configuration UI 220 to select or further specify which content from the service provider should be added to the collaborative workspace environment. For example, FIG. 3 shows the user interface 200 with a different view of the embedded service provider display. The different view may be a result of pressing the “Select account” button displayed in FIG. 2. In this example, input fields 250 may be used to provide additional information to the service provider. Input fields 250 may be displayed by configuration UI 220 as a result of specific information or resources provided by the service provider. As described previously, the input fields 250, including the names of the input fields 250, and the content that is specified in the input fields 250, is not known by the collaborative workspace environment. This information is provided from the service provider. As an example, input fields 250 may be part of a webpage which was retrieved and embedded within configuration UI 220.

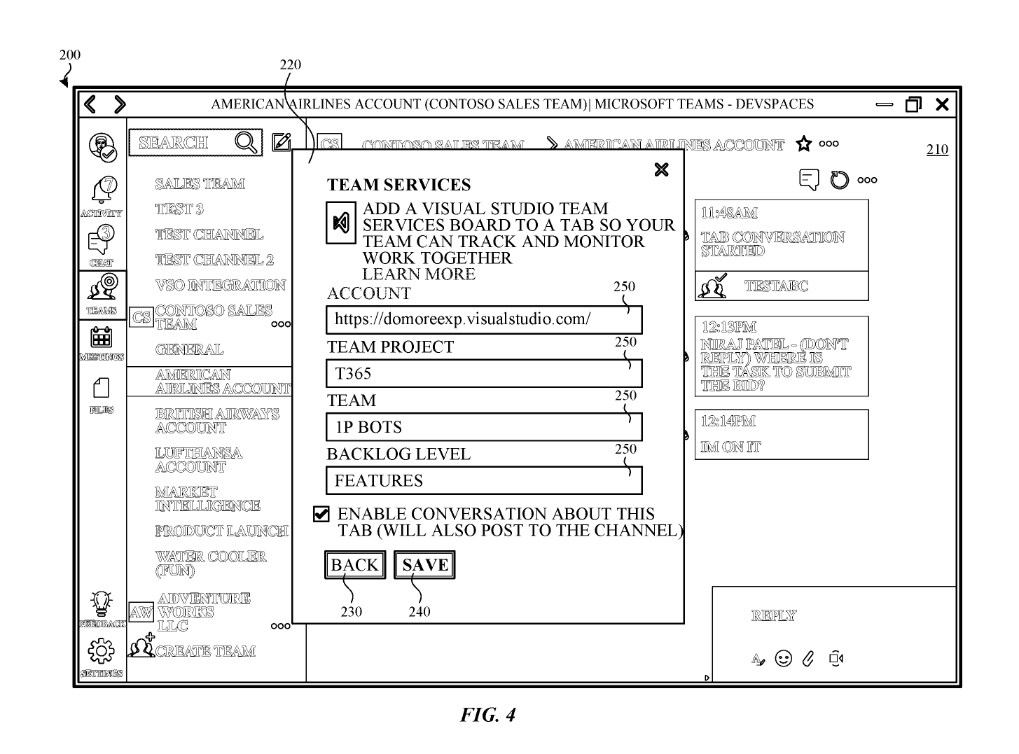

FIG. 4 shows the user interface 200 from FIG. 3 with information entered into input fields 250. This information may be information that the service provider has access to but the collaborative workspace environment does not. In other implementations, the information may be accessible by both the service provider and the collaborative workspace environment.

As a result of completing the content selection process as specified by the service provider (e.g., completing all of the fields present within the embedded webpage), the service provider may provide an indication to configuration UI 220. As a result of the indication, configuration UI 220 may enable “Save” button 240. In some examples, configuration UI 220 may take additional action, including, but not limited to, updating other graphical elements or automatically performing additional tasks associated with the UI.

In response to pressing “Save” button 240, an indication may be provided to the service provider. As a result, the service provider may provide one or more entities relating to the content addition as specified within configuration UI 220. The one or more entities may be stored and retrieved to generate a display of the selected content from the service provider. In some examples, the one or more entities may comprise a URL relating to the content, wherein the URL may be stored and later retrieved by the collaborative workspace environment to generate a display of the content within the collaborative workspace environment.

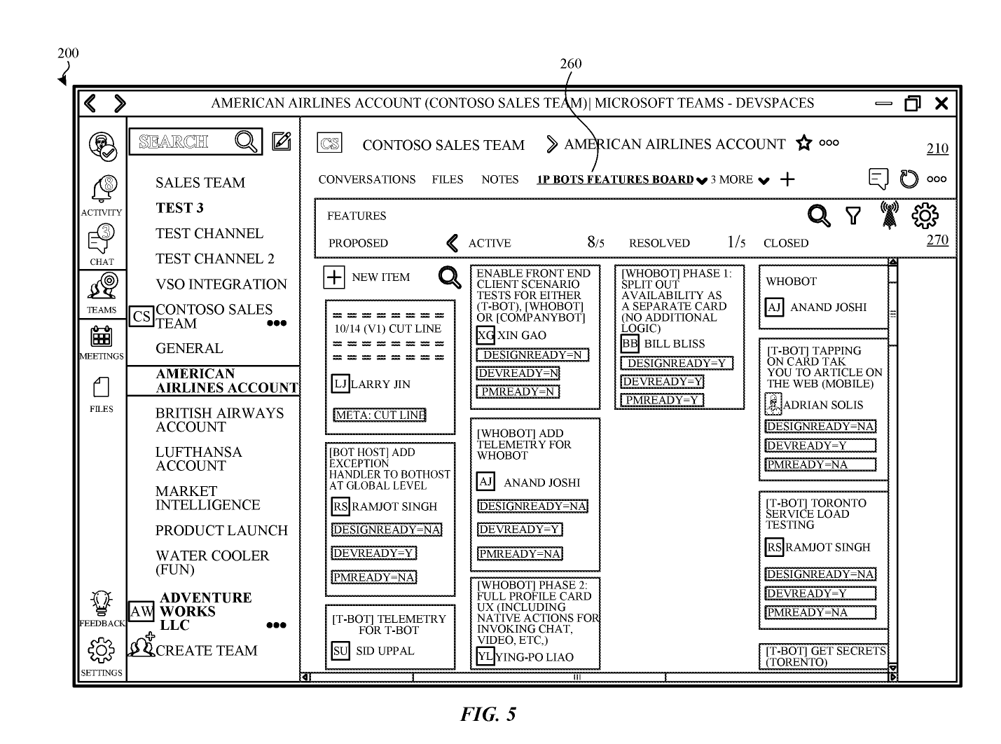

For example, FIG. 5 shows user interface 200 with a new canvas that has been created using the information provided to configuration UI 220 in FIG. 4. Workspace 210 comprises newly-created canvas 260 and embedded content 270. Embedded content 270 may be displayed using one or more entities received from the service provider. As an example, the display may comprise an embedded frame in which a website has been loaded based on a URL provided by the service provider.

In some examples, the entities received from the service provider may be shared within the collaborative workspace environment independent from whether a recipient of the entities added content from the service provider (e.g., by using an embedded service provider display such as configuration UI 220). More specifically, other members within a group may be able to view the content associated with the one or more entities received from the service provider, despite not utilizing configuration UI 220 to add canvas 260 as described above.

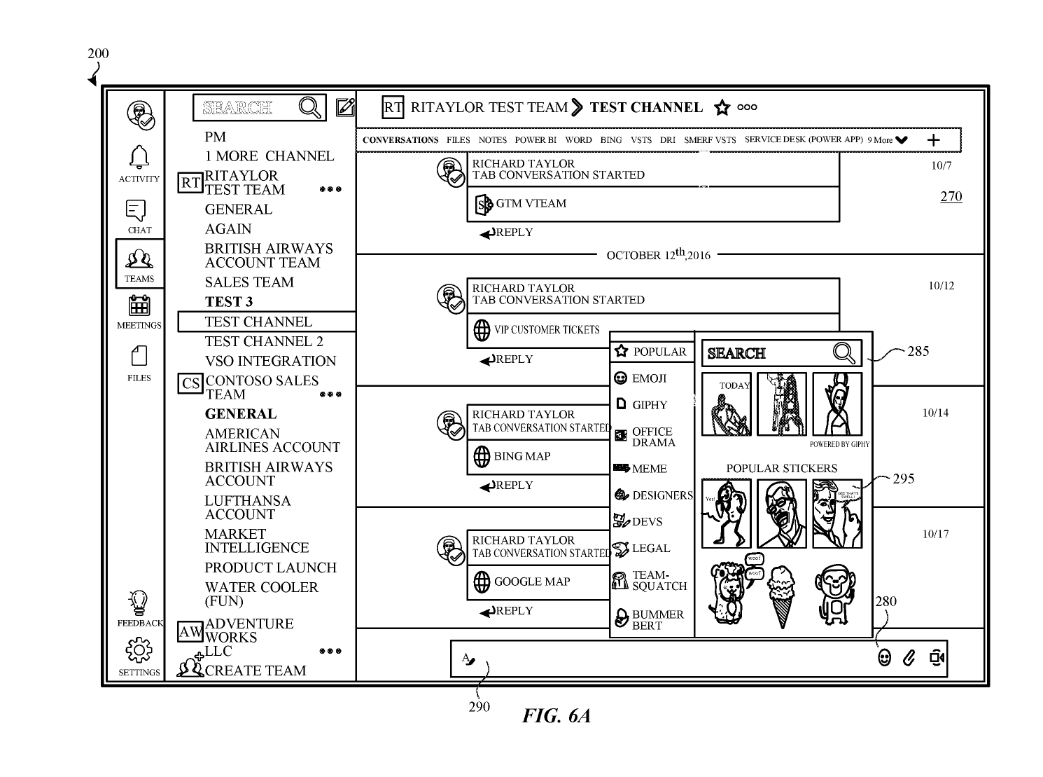

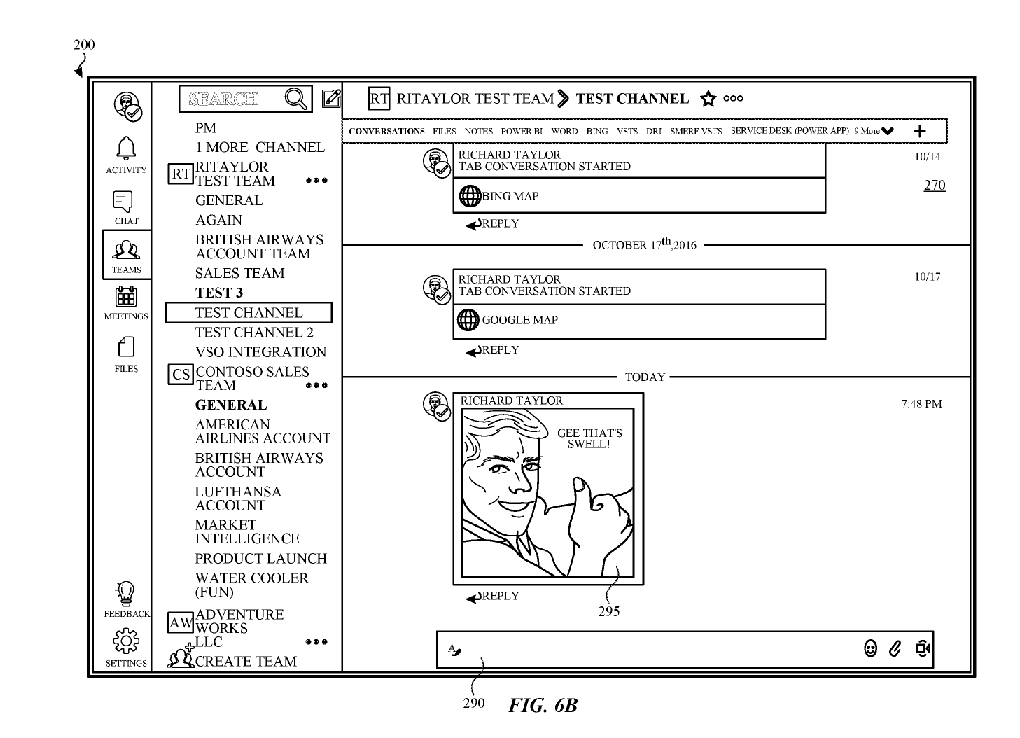

FIG. 6A illustrates example user interface 200 with an embedded service provider display (e.g., selector UI 285). Selector UI 285 may be activated as a result of pressing button 280. Similar to configuration UI 220, selector UI 285 may retrieve specific information or resources specified by a service provider when generating its display. As an example, a URL may be provided which may be used to retrieve a webpage for display within selector UI 285. The webpage may be embedded using a frame (e.g., an iframe) or similar interface element. The webpage may comprise a variety of elements (e.g. item 295), which may be selected by a user. In some instances, the collaborative workspace environment may not have knowledge of and/or access to the specific content.

A user may interact with selector UI 285 to select an item from the display (e.g., item 295). As a result of the selection, the collaborative workspace environment may receive an indication from the service provider containing one or more entities relating to the selection. The one or more entities may be stored and used to generate a display of the selected content from the service provider within compose box 290. Similarly, when the message is added to workspace 270 (e.g., sent to other users), the entities may be used by other recipients to generate a display of the selected content from the service provider. As a result, the service provider may control the appearance and user experience aspects of selector UI 285, while providing one or more entities that the collaborative workspace environment may use to display the content from the service provider.

For example, FIG. 6B shows user interface 200 where item 295 has been selected using selector UI 285, as described above with respect to FIG. 6A. As a result, item 295 has been added to workspace 270. Item 295 may be displayed in workspace 270 using one or more entities associated with item 295. In some examples, the one or more entities may comprise a URL, wherein the display of item 295 is generated from resources made available by the service provider at the URL. Further, item 295 may be shared within the collaborative workspace environment, such that other users may generate a similar view using the entities associated with item 295.

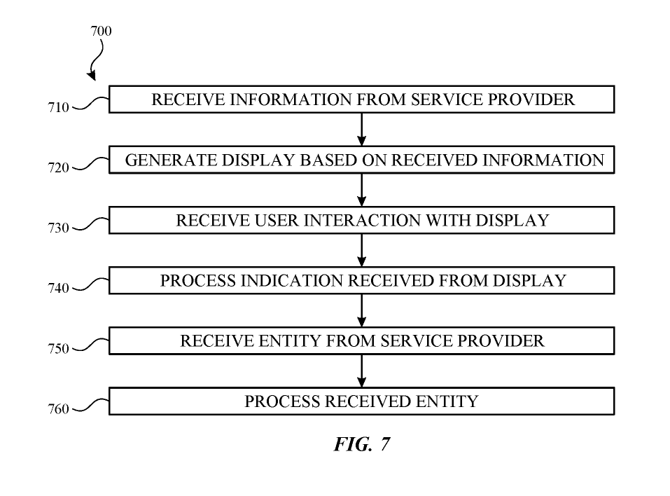

FIG. 7 illustrates an example method 700 for an embedded service provider display. In some examples, method 700 may be used to display a user interface specified by a service provider and receive one or more entities in response to a user selection within the display.

Method 700 begins at operation 710 in which information is received from a service provider. The information may indicate specific information or resources to use when generating a display. As an example, a uniform resource locator (URL) or other identifier may be provided which may be associated with a webpage to embed within the user interface.

In operation 720, the received information may be used to generate an embedded service provider display. As an example, the received information may comprise a URL. The URL may be displayed within an embedded frame within the user interface, thereby enabling the service provider to customize the appearance and user experience of the display. Although not specifically mentioned herein, other graphical elements may be provided and used to generate and/or display a configuration UI such as described herein.

A user interaction may be received by the display in operation 730. The user interaction may include navigating a directory structure, inputting additional information (e.g., authentication credentials), or searching for specific content, among other interactions. In some examples, the user interaction may be processed exclusively or directly by the generated display rather than by other components of the user interface.

At operation 740, an indication from the display may be received and processed. In some examples, the indication may be received because the display determined that the user has completed the content selection process. When processing the received indication, the user interface may update elements of the user interface (e.g., a “Save” button may become enabled, thereby enabling a user to submit the information entered within the display to the service provider). In other examples, processing the received indication may comprise performing additional tasks automatically (e.g., the content addition may be automatically submitted to the service provider, rather than requesting further user input).

Moving to operation 750, one or more entities may be received from the service provider. In some examples, the entities may be received as a result of a submission provided to the service provider in operation 740. In other examples, the indication may be received automatically as a result of the display determining that the user has completed the content selection process. In some examples, the one or more received entities may comprise a URL relating to the content, wherein the URL relates to a webpage associated with the content selected or specified within the display.

Finally, at operation 760, the received entities may be processed. Processing the one or more entities may comprise storing them either locally on the computing device or remotely in a storage system. The entities may also be used to generate a display of the selected content from the service provider. In some examples, the entities may be sent to or accessed by other users within the collaborative workspace environment to access the content from the service provider.

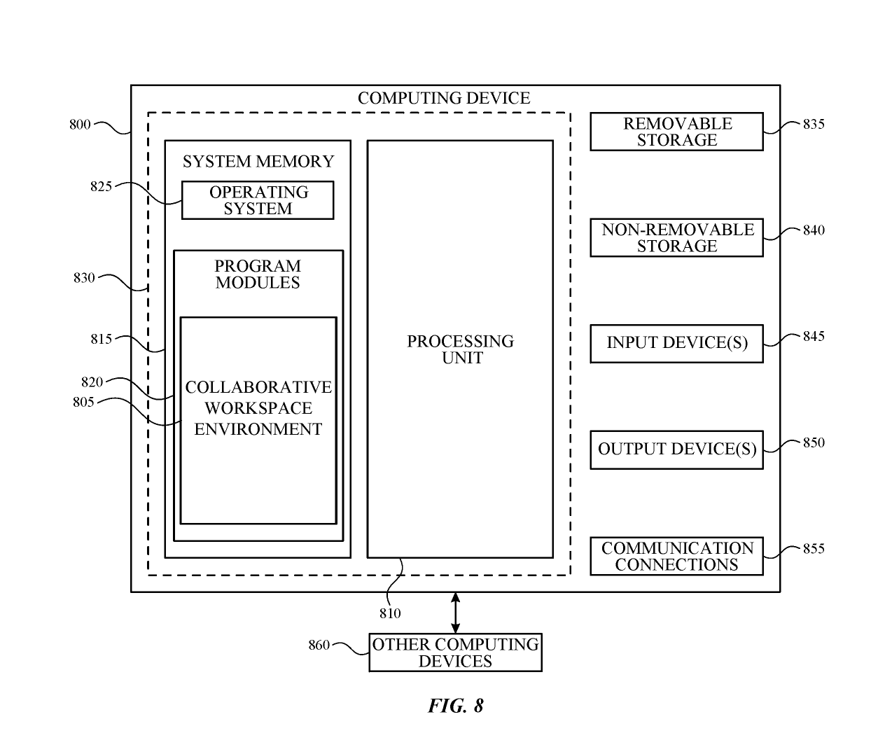

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of electronic device configurations that may be utilized for practicing aspects of the disclosure, as described herein.

FIG. 8 is a block diagram illustrating physical components (e.g., hardware) of an electronic device 800 with which aspects of the disclosure may be practiced. The computing device components described below may be suitable for the computing devices described above, including the client computing devices 110A and 110B and the server computing device 120.

In a basic configuration, the electronic device 800 may include at least one processing unit 810 and a system memory 815. Depending on the configuration and type of electronic device, the system memory 815 may comprise, but is not limited to, volatile storage (e.g., random access memory), non-volatile storage (e.g., read-only memory), flash memory, or any combination of such memories. The system memory 815 may include an operating system 825 and one or more program modules 820 suitable for parsing received input, determining subject matter of received input, determining actions associated with the input and so on.

The operating system 825, for example, may be suitable for controlling the operation of the electronic device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 830.

The electronic device 800 may have additional features or functionality. For example, the electronic device 800 may also include additional data storage devices (removable and/or non-removable) such as, for example, magnetic disks, optical disks, or tape. Such additional storage is illustrated in FIG. 8 by a removable storage device 835 and a non-removable storage device 840.

As stated above, a number of program modules and data files may be stored in the system memory 815. While executing on the processing unit 810, the program modules 820 (e.g., the collaborative workspace environment module 805) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The electronic device 800 may also have one or more input device(s) 845 such as a keyboard, a trackpad, a mouse, a pen, a sound or voice input device, a touch, force and/or swipe input device, etc. The output device(s) 850 such as a display, speakers, a printer, etc. may also be included. The aforementioned devices are examples and others may be used. The electronic device 800 may include one or more communication connections 855 allowing communications with other electronic devices 860. Examples of suitable communication connections 855 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 815, the removable storage device 835, and the non-removable storage device 840 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 800. Any such computer storage media may be part of the electronic device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

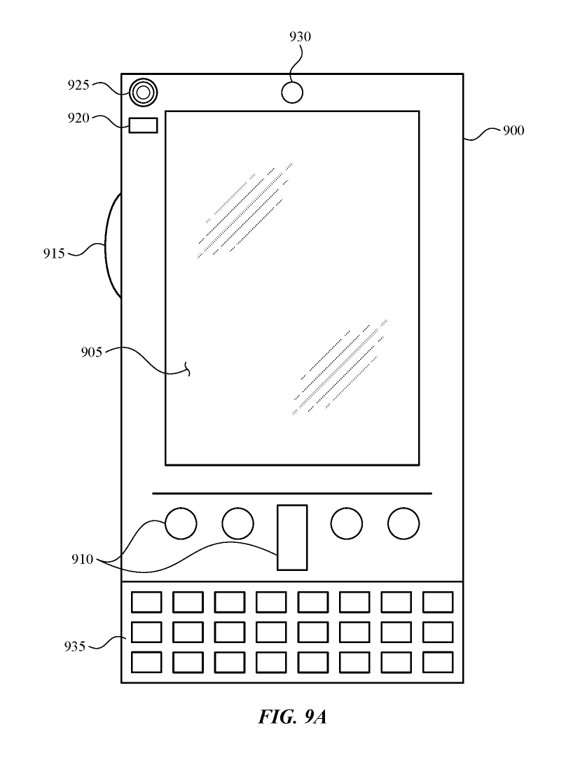

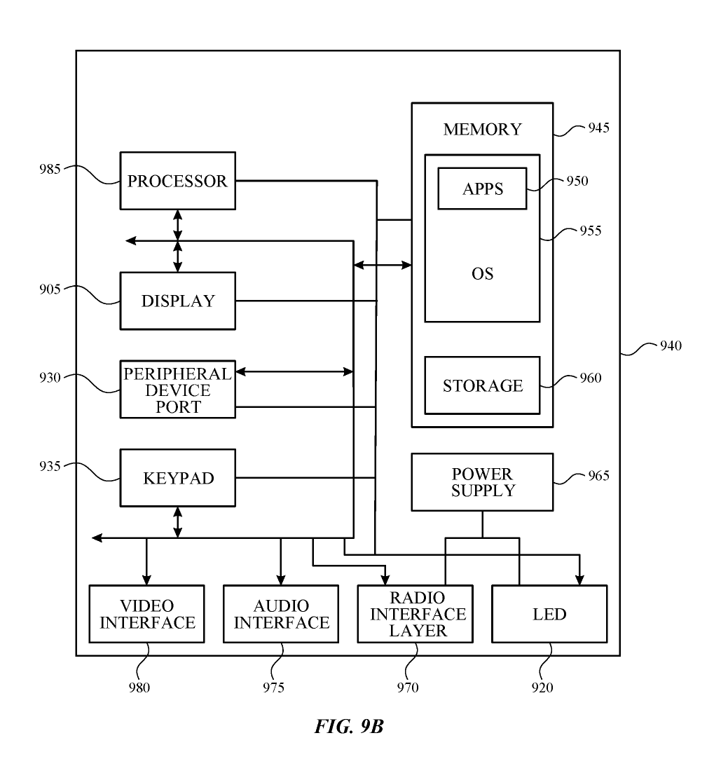

FIGS. 9A and 9B illustrate a mobile electronic device 900, for example, a mobile telephone, a smart phone, wearable computer (such as a smart watch), a tablet computer, a laptop computer, and the like, with which embodiments of the disclosure may be practiced. With reference to FIG. 9A, one aspect of a mobile electronic device 900 for implementing the aspects is illustrated.

In a basic configuration, the mobile electronic device 900 is a handheld computer having both input elements and output elements. The mobile electronic device 900 typically includes a display 905 and one or more input buttons 910 that allow the user to enter information into the mobile electronic device 900. The display 905 of the mobile electronic device 900 may also function as an input device (e.g., a display that accepts touch and/or force input).

If included, an optional side input element 915 allows further user input. The side input element 915 may be a rotary switch, a button, or any other type of manual input element. In alternative aspects, mobile electronic device 900 may incorporate more or less input elements. For example, the display 905 may not be a touch screen in some embodiments. In yet another alternative embodiment, the mobile electronic device 900 is a portable phone system, such as a cellular phone. The mobile electronic device 900 may also include an optional keypad 935. Optional keypad 935 may be a physical keypad or a “soft” keypad generated on the touch screen display.

In various embodiments, the output elements include the display 905 for showing a graphical user interface (GUI), a visual indicator 920 (e.g., a light emitting diode), and/or an audio transducer 925 (e.g., a speaker). In some aspects, the mobile electronic device 900 incorporates a vibration transducer for providing the user with tactile feedback. In yet another aspect, the mobile electronic device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile electronic device 900. That is, the mobile electronic device 900 can incorporate a system (e.g., an architecture) 940 to implement some aspects. In one embodiment, the system 940 is implemented as a “smart phone” capable of running one or more applications (e.g., browser, e-mail, calendaring, contact managers, messaging clients, games, media clients/players, content selection and sharing applications and so on). In some aspects, the system 940 is integrated as an electronic device, such as an integrated personal digital assistant (PDA) and wireless phone.

One or more application programs 950 may be loaded into the memory 945 and run on or in association with the operating system 955. Examples of the application programs include phone dialer programs, e-mail programs, personal information management (PIM) programs, word processing programs, spreadsheet programs, Internet browser programs, messaging programs, and so forth.

The system 940 also includes a non-volatile storage area 960 within the memory 945. The non-volatile storage area 960 may be used to store persistent information that should not be lost if the system 940 is powered down.

The application programs 950 may use and store information in the non-volatile storage area 960, such as email or other messages used by an email application, and the like. A synchronization application (not shown) also resides on the system 940 and is programmed to interact with a corresponding synchronization application resident on a host computer to keep the information stored in the non-volatile storage area 960 synchronized with corresponding information stored at the host computer.

The system 940 has a power supply 965, which may be implemented as one or more batteries. The power supply 965 may further include an external power source, such as an AC adapter or a powered docking cradle that supplements or recharges the batteries.

The system 940 may also include a radio interface layer 970 that performs the function of transmitting and receiving radio frequency communications. The radio interface layer 970 facilitates wireless connectivity between the system 940 and the “outside world,” via a communications carrier or service provider. Transmissions to and from the radio interface layer 970 are conducted under control of the operating system 955. In other words, communications received by the radio interface layer 970 may be disseminated to the application programs 950 via the operating system 955, and vice versa.

The visual indicator 920 may be used to provide visual notifications, and/or an audio interface 975 may be used for producing audible notifications via an audio transducer (e.g., audio transducer 925 illustrated in FIG. 9A). In the illustrated embodiment, the visual indicator 920 is a light emitting diode (LED) and the audio transducer 925 may be a speaker. These devices may be directly coupled to the power supply 965 so that when activated, they remain on for a duration dictated by the notification mechanism even though the processor 985 and other components might shut down for conserving battery power. The LED may be programmed to remain on indefinitely until the user takes action to indicate the powered-on status of the device.

The audio interface 975 is used to provide audible signals to and receive audible signals from the user (e.g., voice input such as described above). For example, in addition to being coupled to the audio transducer 925, the audio interface 975 may also be coupled to a microphone to receive audible input, such as to facilitate a telephone conversation. In accordance with embodiments of the present disclosure, the microphone may also serve as an audio sensor to facilitate control of notifications, as will be described below.

The system 940 may further include a video interface 980 that enables an operation of peripheral device 930 (e.g., on-board camera) to record still images, video stream, and the like. The captured images may be provided to the artificial intelligence entity advertisement system such as described above.

A mobile electronic device 900 implementing the system 940 may have additional features or functionality. For example, the mobile electronic device 900 may also include additional data storage devices (removable and/or non-removable) such as, magnetic disks, optical disks, or tape. Such additional storage is illustrated in FIG. 9B by the non-volatile storage area 960.

Data/information generated or captured by the mobile electronic device 900 and stored via the system 940 may be stored locally on the mobile electronic device 900, as described above, or the data may be stored on any number of storage media that may be accessed by the device via the radio interface layer 970 or via a wired connection between the mobile electronic device 900 and a separate electronic device associated with the mobile electronic device 900, for example, a server computer in a distributed computing network, such as the Internet. As should be appreciated such data/information may be accessed via the mobile electronic device 900 via the radio interface layer 970 or via a distributed computing network. Similarly, such data/information may be readily transferred between electronic devices for storage and use according to well-known data/information transfer and storage means, including electronic mail and collaborative data/information sharing systems.

As should be appreciated, FIG. 9A and FIG. 9B are described for purposes of illustrating the present methods and systems and is not intended to limit the disclosure to a particular sequence of steps or a particular combination of hardware or software components.

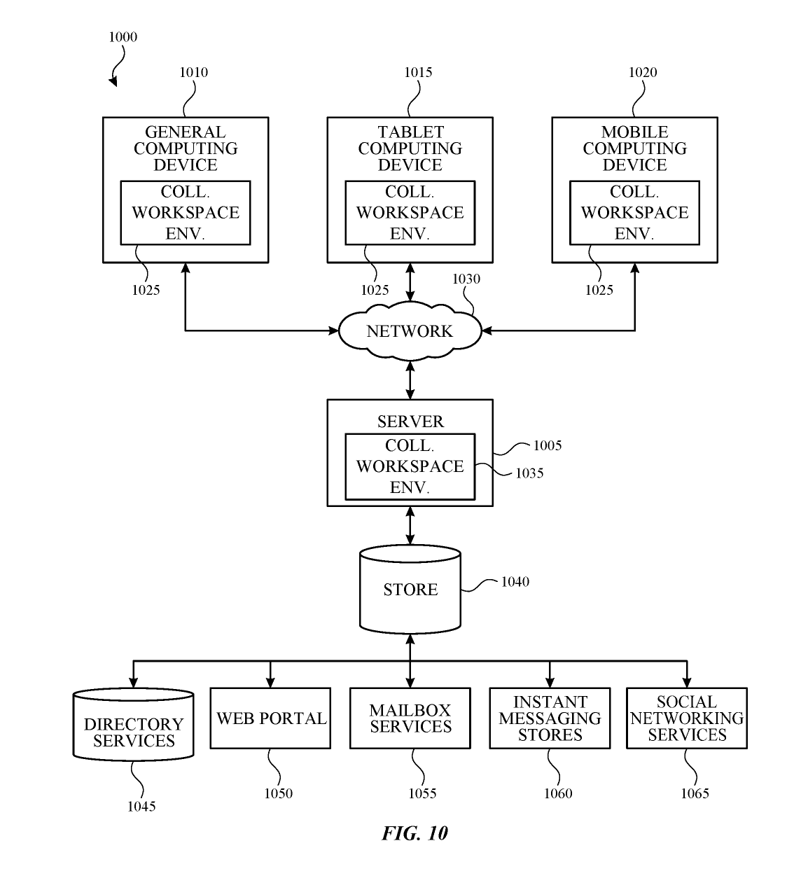

FIG. 10 illustrates one aspect of the architecture of a system 1000 such as described herein. The system may include a general electronic device 1010 (e.g., personal computer), tablet electronic device 1015, or mobile electronic device 1020, as described above. Each of these devices may include a collaborative workspace environment 1025 for collaborating with a group as described above. Each collaborative workspace environment may access a network 1030 to interact with and update a collaborative workspace environment 1035 stored on a server 1005.

In some aspects, the collaborative workspace environment 1035 may receive various types of information or content that is stored by the store 1040 or transmitted from a directory service 1045, a web portal 1050, mailbox services 1055, instant messaging stores 1060, or social networking services 1065.

By way of example, the aspects described above may be embodied in a general electronic device 1010 (e.g., personal computer), a tablet electronic device 1015 and/or a mobile electronic device 1020 (e.g., a smart phone). Any of these embodiments of the electronic devices may obtain content from or provide data to the store 1040.

As should be appreciated, FIG. 10 is described for purposes of illustrating the present methods and systems and is not intended to limit the disclosure to a particular sequence of steps or a particular combination of hardware or software components.

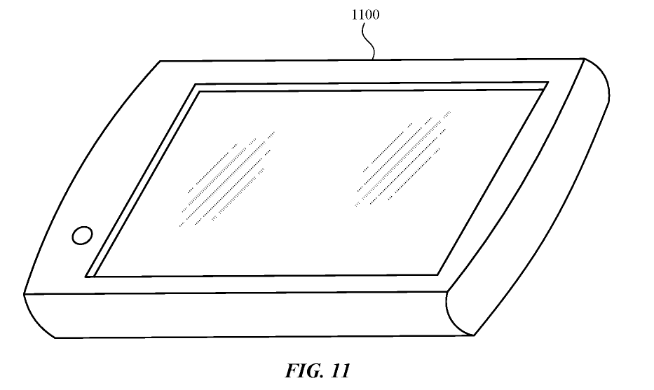

FIG. 11 illustrates an example tablet electronic device 1100 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices.

For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 11 is described for purposes of illustrating the present methods and systems and is not intended to limit the disclosure to a particular sequence of steps or a particular combination of hardware or software components.

As will be understood from the foregoing disclosure, one aspect of the technology relates to a system comprising: at least one processing unit; and at least one memory storing computer executable instructions which, when executed by the at least one processing unit, performs a method. The method comprises: receiving one or more resources from a service provider, wherein the one or more resources are specific to the service provider; generating a first display within a user interface of a collaborative workspace environment using the one or more resources, wherein the first display comprises one or more input fields; receiving an input in the one or more input fields of the first display; in response to receiving the input in the one or more input fields, receiving one or more entities from the service provider, wherein the one or more entities are associated with the input; and generating a second display within the user interface of the collaborative workspace environment that contains the one or more entities. In an example, the method further comprises providing the one or more entities to one or more recipients that access the collaborative workspace environment. In another example, the one or more resources comprise a webpage. In a further example, the method further comprises: receiving, from the first display, an indication relating to the one or more input fields; and based on the indication, updating at least one of the one or more input fields of the first display. In yet another example, the method further comprises: receiving, from the first display, an indication relating to the one or more input fields; and based on the indication, transmitting information from the one or more input fields to the service provider. In a further still example, the one or more entities comprise a webpage. In one example, the webpage is generated based on information from the one or more input fields.

In another aspect, the technology relates to a computer-implemented method. The method comprises: receiving one or more resources from a service provider, wherein the one or more resources are specific to the service provider; generating a first display within a user interface of a collaborative workspace environment using the one or more resources, wherein the first display comprises one or more input fields; receiving an input in the one or more input fields of the first display; in response to receiving the input in the one or more input fields, receiving one or more entities from the service provider, wherein the one or more entities are associated with the input; and generating a second display within the user interface of the collaborative workspace environment that contains the one or more entities. In an example, the method further comprises providing the one or more entities to one or more recipients that access the collaborative workspace environment. In another example, the one or more resources comprise a first webpage and wherein the one or more entities comprise a second webpage. In a further example, the method further comprises: receiving, from the first display, an indication relating to the one or more input fields; and based on the indication, updating the first display. In yet another example, the method further comprises: receiving, from the first display, an indication relating to the one or more input fields; and based on the indication, transmitting information from the one or more input fields from the one or more input fields to the service provider. In a further still example, the first display and the second display are frames within the user interface of the collaborative workspace environment. In another example, the second webpage is generated based on information from the one or more input fields.

In another aspect, the technology relates to another computer-implemented method. The method comprises: receiving one or more resources from a service provider, wherein the one or more resources are specific to the service provider; generating a first display within a user interface of a collaborative workspace environment using the one or more resources, wherein the first display comprises one or more input fields; receiving an input in the one or more input fields of the first display; in response to receiving the input in the one or more input fields, receiving one or more entities from the service provider, wherein the one or more entities are associated with the input; generating a second display within the user interface of the collaborative workspace environment that contains the one or more entities; and providing the one or more entities to one or more recipients that access the collaborative workspace environment. In an example, one or more resources comprise a webpage. In another example, the method further comprises: receiving, from the first display, an indication relating to the one or more input fields; and based on the indication, updating the first display. In a further example, the method further comprises: receiving, from the first display, an indication relating to the one or more input fields; and based on the indication, transmitting information from the one or more input fields to the service provider. In yet another example, the one or more entities comprise a webpage. In a further still example, the webpage is generated based on information from the first display.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system, comprising:
at least one processing unit; and
at least one memory storing computer executable instructions which, when executed by the at least one processing unit, performs a method, comprising:
receiving one or more resources from a service provider, wherein the one or more resources are specific to the service provider;
generating a first display within a user interface of a collaborative workspace environment using the one or more resources, wherein the first display comprises one or more input fields;
receiving an input in the one or more input fields of the first display;
in response to receiving the input in the one or more input fields, receiving one or more entities from the service provider, wherein the one or more entities are associated with the input; and
generating a second display within the user interface of the collaborative workspace environment that contains the one or more entities.

2. The system of claim 1, further comprising instructions for:
providing the one or more entities to one or more recipients that access the collaborative workspace environment.

3. The system of claim 1, wherein the one or more resources comprise a webpage.

4. The system of claim 1, further comprising instructions for:
receiving, from the first display, an indication relating to the one or more input fields; and
based on the indication, updating at least one of the one or more input fields of the first display.

5. The system of claim 1, further comprising instructions for:
receiving, from the first display, an indication relating to the one or more input fields; and
based on the indication, transmitting information from the one or more input fields to the service provider.

6. The system of claim 1, wherein the one or more entities comprise a webpage.

7. The system of claim 6, wherein the webpage is generated based on information from the one or more input fields.

8. A computer-implemented method, comprising:
receiving one or more resources from a service provider, wherein the one or more resources are specific to the service provider;
generating a first display within a user interface of a collaborative workspace environment using the one or more resources, wherein the first display comprises one or more input fields;
receiving an input in the one or more input fields of the first display;
in response to receiving the input in the one or more input fields, receiving one or more entities from the service provider, wherein the one or more entities are associated with the input; and
generating a second display within the user interface of the collaborative workspace environment that contains the one or more entities.

9. The method of claim 8, further comprising providing the one or more entities to one or more recipients that access the collaborative workspace environment.

10. The method of claim 8, wherein the one or more resources comprise a first webpage and wherein the one or more entities comprise a second webpage.

11. The method of claim 8, further comprising:
receiving, from the first display, an indication relating to the one or more input fields; and
based on the indication, updating the first display.

12. The method of claim 8, further comprising:
receiving, from the first display, an indication relating to the one or more input fields; and
based on the indication, transmitting information from the one or more input fields from the one or more input fields to the service provider.

13. The method of claim 8, wherein the first display and the second display are frames within the user interface of the collaborative workspace environment.

14. The method of claim 10, wherein the second webpage is generated based on information from the one or more input fields.

15. A computer-implemented method, comprising:
receiving one or more resources from a service provider, wherein the one or more resources are specific to the service provider;
generating a first display within a user interface of a collaborative workspace environment using the one or more resources, wherein the first display comprises one or more input fields;
receiving an input in the one or more input fields of the first display;
in response to receiving the input in the one or more input fields, receiving one or more entities from the service provider, wherein the one or more entities are associated with the input;
generating a second display within the user interface of the collaborative workspace environment that contains the one or more entities; and
providing the one or more entities to one or more recipients that access the collaborative workspace environment.

16. The computer-implemented method of claim 15, wherein the one or more resources comprise a webpage.

17. The computer-implemented method of claim 15, further comprising:
receiving, from the first display, an indication relating to the one or more input fields; and
based on the indication, updating the first display.

18. The computer-implemented method of claim 15, further comprising:
receiving, from the first display, an indication relating to the one or more input fields; and
based on the indication, transmitting information from the one or more input fields to the service provider.

19. The computer-implemented method of claim 15, wherein the one or more entities comprise a webpage.

20. The computer-implemented method of claim 19, wherein the webpage is generated based on information from the first display.
